(19) United States
(12) Patent Application Publication
(10) Pub. No.: US 2006/0075003 A1
(43) Pub. Date: Apr. 6, 2006

(54) Queuing of location-based task oriented content

(75) Inventors: Samuel Scott Adams, Apex, NC (US); Fonda J. Daniels, Cary, NC (US); Ruthie D. Lyle, Durham, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/944,582

(22) Filed: Sep. 17, 2004

(51) Int. Cl. G06F 17/30; G06F 12/00

(52) U.S. Cl. 707/204

(57) ABSTRACT

A method, system, and computer instructions for the queuing of location-based task-oriented content. A content service provider receives content for a location-dependent task to be delivered to a particular client computing device. The content service provider determines if the content is above a threshold associated with the location-dependent task. Responsive to a determination that the content is above the threshold, rerouting the content to a storage repository associated with another location-dependent task, wherein a user may address the content at a later time.

### BACKGROUND OF THE INVENTION

1. Technical Field

The present invention relates generally to an improved data processing system. In particular, the present invention relates to a method, apparatus, and computer instructions for managing the delivery of location and task oriented content to a user.

2. Description of Related Art

Portable devices, such as personal digital assistants (PDAs), laptop computers, and mobile phones, have become more pervasive in everyday use. Notebook computers often take the place of a desktop computer and allow a user to take work to various locations, including customer sites. Handheld computers and mobile phones often contain computing functions and resources that allow users to communicate and exchange documents and other data with others while the users are outside of the office. These computing functions generally include communication applications to help a user stay in touch with other persons at home or in the office, such as voice mail, e-mail, instant messaging, or two-way paging with short text messages.

In a pervasive computing environment, a user may create and maintain location-dependent preferences for a computing device. For example, a user who travels between two or more cities may want to set preferences specific to the particular city in which the user is currently located. In this manner, when the user is in one city, user settings specific to that city are employed in the computer device. In addition to setting location preferences, a user may also set preferences related to task to further define how content is delivered to the user. For instance, a user may establish that the content service provider considers the task related to the content; such that email content is delivered to the user's email account, phone content is delivered to the user's cell phone, etc. Thus, task-oriented preference information may be added to location-dependent preferences, thereby providing additional information that is directly related to the immediate task at hand.

However, with existing location-based task-oriented content delivery, a user can easily get overwhelmed by the delivery of content that is related to the location-based task. The user may receive more content related to the task than the user is able to handle at that particular time. Delivered content in excess of what the user is able to address at that particular time is regarded as unaccomplishable or as an undesirable interruption.

Therefore, it would be advantageous to have an improved method and apparatus for allowing a user to define the number of content deliveries the user can handle regarding a particular task, and queuing content that exceeds the acceptable number of deliveries for later viewing.

### BRIEF SUMMARY OF THE INVENTION

The present invention provides a method, system, and computer instructions for the queuing of location-based task-oriented content. A content service provider receives content for a location-dependent task to be delivered to a particular client computing device. The content service provider determines if the content is above a threshold associated with the location-dependent task. Responsive to a determination that the content is above the threshold, rerouting the content to a storage repository associated with another location-dependent task, wherein a user may address the content at a later time.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram of exemplary user preferences and content delivery in accordance with the present invention; and

FIG. 5 is a flowchart of a process for queuing location-based task-oriented content in accordance with a preferred embodiment of the present invention.

### DETAILED DESCRIPTION OF THE INVENTION

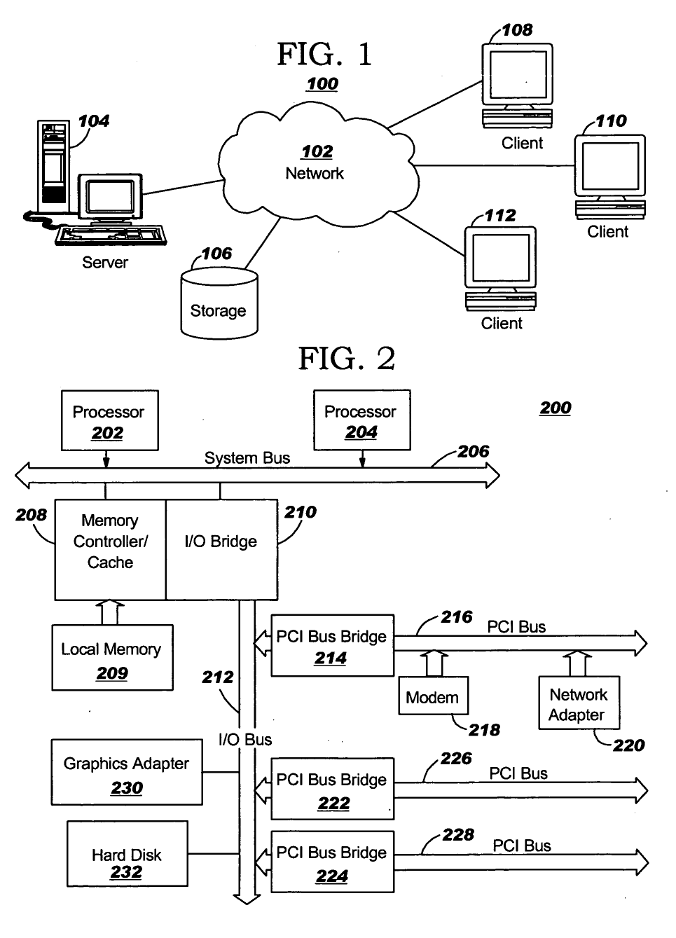

With reference now to the figures, FIG. 1 depicts a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers or personal digital assistants (PDA) devices. In the depicted example, server 104 provides data, such as boot files, operating system images, and applications to clients 108-112. Clients 108, 110, and 112 are clients to server 104. Server 104 may act as an instant messaging server to facilitate the exchange of messages between users at clients, such as clients 108, 110, and 112. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

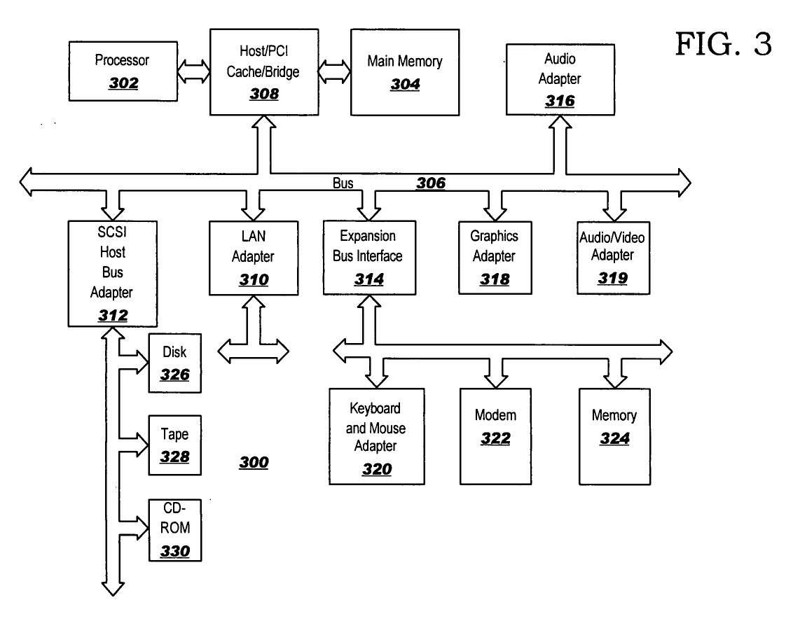

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 may be a notebook computer, mobile phone, or a hand held computer in addition to taking the form of a PDA, and the like.

The present invention provides a method, apparatus, and computer instructions for queuing location-based task-oriented content. The mechanism of the present invention allows a user to define the number of content deliveries the user can handle for a particular task. The user defines the number of content deliveries the user can handle in terms of a threshold that is associated with each location-dependent task. As long as the incoming content is below the threshold set by the user, the content will be delivered to the user device. However, if the number of content deliveries the user can handle exceeds the acceptable number of deliveries established by the user (i.e., the content is above the threshold set by the user), the content is rerouted to a storage repository associated with another location-dependent task to store the delivered content. For example, if the content is in the form an instant message and the threshold for the task has been exceeded, rather than delivering the instant message to the user, the content is rerouted to the user's email inbox. In this manner, the user is not interrupted with content that the user is not able to presently address, and the user is able to access the content in the storage repository at a later time.

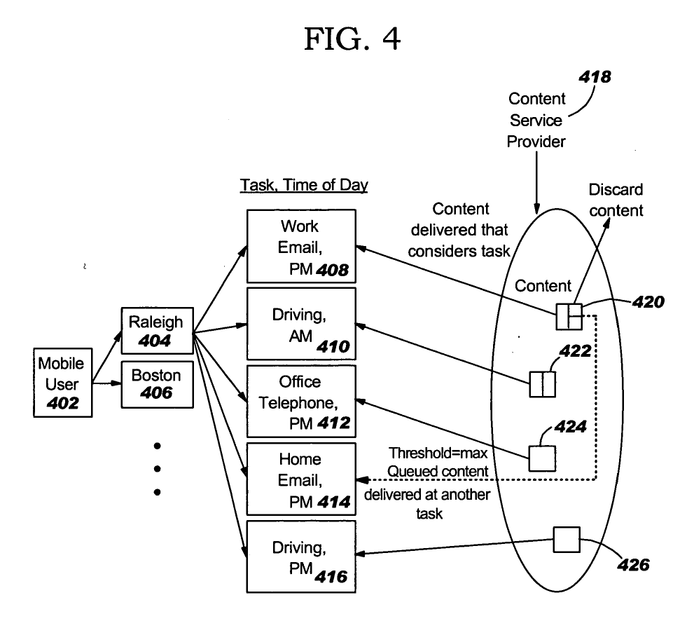

Turning now to FIG. 4, a block diagram of exemplary user preferences and content delivery in accordance with the present invention is shown. The content delivery shown in FIG. 4 may be implemented in a distributed data processing system, such as network data processing system 100 in FIG. 1. Mobile user 402 is an example of a client, such as clients 108, 110, and 112 in FIG. 1. Content service provider 418 is an example of a server, such as server 104 in FIG. 1.

In this illustrative example, mobile user 402 is shown to have multiple location preferences 404 and task preferences 406. These preferences are set by mobile user 402. Mobile user 402 has two location preferences, Raleigh 404 and Boston 406, although additional location preferences may be used. Each location preference may comprise one or more user task preferences, such as, for example, work email PM 408, driving AM 410, office telephone PM 412, home email PM 414, and driving PM 416.

Content service provider 418 delivers content to mobile user 402 in view of the tasks specified by the user preferences. For example, when content service provider 418 receives content 420 to be delivered to mobile user 402, content service provider 418 considers the location and task for the content, in this case Raleigh 404 and work email PM 424, respectively, and delivers the content accordingly. Likewise, content 422 is delivered to mobile user 402 based on driving AM 410 task, content 424 is delivered based on office telephone 412 task, and content 426 is delivered to driving PM 416 task.

Preferences set by the user further manage the delivery of content for each location-based task. Prior to the delivery of content to a location-dependent task, mobile user 402 defines the number of content deliveries mobile user 402 is able to address for each location-dependent task. Mobile user 402 sets a threshold regarding the number of events mobile user 402 can handle for the task. Content service provider 418 delivers the content to mobile user 402 if the content is below the threshold set by the user. However, if the number of content deliveries mobile user 402 can handle exceeds the acceptable number of deliveries established by the user (i.e., the content is above the threshold set by the user), the content is rerouted to a storage repository associated with another location-dependent task to store the content.

For example, mobile user 402 sets a threshold for work email PM 408 task. When content is received, content service provider 418 considers the task when delivering content 420 to mobile user 402. In this case, content 420 is to be delivered to the mobile user's work email address. However, before content 420 is delivered to the mobile user's work email application, content service provider also determines whether delivering content 420 to mobile user 402 will exceed the allowable number of events mobile user 402 can handle based on the user's preference settings. In this example, the threshold set by mobile user 402 has already been met. As mobile user is not able to address content 420 at this time, content service provider reroutes content 420 to another task, such as home email PM 414 task. As the user sets the maximum threshold for each location-based task, the user may also select one or more alternative tasks to which the content is rerouted. In this manner, content above a threshold set by the user is delivered to another task, wherein the content is queued in a storage repository to be addressed at a later time.

In addition, the present invention also allows for discarding time-sensitive content in a queue when the content expires. For example, if content service provider 418 receives content that requires the user to respond to the content within a certain time period, content service provider 418 may discard the time-sensitive content if the content expires prior to the user being able to address the content. In other words, if content 420 is time-sensitive and the user's threshold has already been met for the location-based task, the content service provider reroutes the time-sensitive content to a designated storage repository for another task. However, when the content expires, content service provider 418 discards time-sensitive content 420.

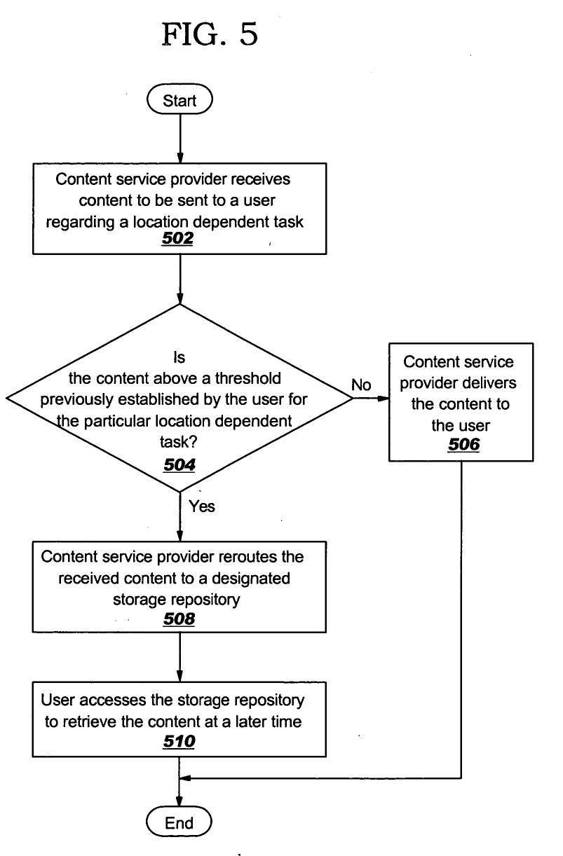

FIG. 5 is a flowchart of a process for queuing location-based task-oriented content in accordance with a preferred embodiment of the present invention. Prior to implementing the steps in FIG. 5, a user establishes a threshold for each location-based task. The process illustrated in FIG. 5 may be implemented in a distributed data processing system, such as data processing system 100 in FIG. 1.

The process begins by receiving content for a location dependent task at the content service provider (step 502). The content service provider is used to deliver content to a mobile user based on the user's location and a task associated with the location. Next, the content service provider determines if the received content is above a threshold previously established by the user for the particular location-dependent task (step 504). For example, if the user has established that the user can only handle between 0-5 events, the received content is above the threshold if five events have already been received for the particular task.

If the received content for the task is below the threshold set by the user, the content service provider delivers the content to the user (step 506), with the process terminating thereafter.

In contrast, if the received content is determined to be above the threshold set by the user, the content service provider reroutes the received content to another medium (step 508), such as a storage repository associated with another location-dependent task, for storing the delivered content. For example, if the content is in the form an email to a work address and the threshold for the work email task has been exceeded, rather than delivering the email to the user, the content is rerouted to the user's home email inbox. Later in the day, when the user is able to address the content related to the work email task, the user may then access the home email inbox to retrieve and address the content (step 510).

Thus, the present invention provides a method, apparatus, and computer instructions for queuing location dependent task content that is determined to be unaccomplishable or that provides an undesirable interruption. The advantages of the present invention should be apparent in view of the detailed description provided above. Location and task dependent preferences may be used to deliver content to a mobile user. However, the user may be inundated with the delivery of content for a particular task despite the user not being able to address the content related to the task at that instance in time. The present invention solves this problem by allowing users to set a threshold that is associated with each location-dependent task. When the threshold is met, content related to the task is rerouted to another task for storing the delivered content, thus allowing the user to access the content at a later time.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for queuing location-based task-oriented content, comprising:
receiving content for a first location-dependent task, wherein the content is to be delivered to a particular client computing device;
determining if the content is above a threshold associated with the first location-dependent task; and
responsive to a determination that the content is above the threshold, rerouting the content to a storage repository associated with a second location-dependent task, wherein rerouting the content allows a user to address the content at a later time.

2. The method of claim 1, further comprising:
delivering the content to the user if the content for the first location-dependent task is below the threshold.

3. The method of claim 1, further comprising:
determining if the content is time-sensitive; and
responsive to a determination that the content is time-sensitive, discarding the content from the second location-dependent task storage repository when the content expires.

4. The method of claim 1, wherein the receiving, determining, and rerouting steps are performed using a content service provider.

5. The method of claim 1, wherein the threshold is set by the user.

6. The method of claim 5, wherein the threshold is set to define a maximum number of content deliveries the user can handle for a particular task.

7. The method of claim 6, wherein rerouting the content prevents the user from being interrupted with content that the user is not able to presently address.

8. A data processing system for queuing location-based task-oriented content, comprising:
receiving means for receiving content for a first location-dependent task, wherein the content is to be delivered to a particular client computing device;
determining means for determining if the content is above a threshold associated with the first location-dependent task; and
rerouting means for rerouting the content to a storage repository associated with a second location-dependent task in response to a determination that the content is above the threshold, wherein rerouting the content allows a user to address the content at a later time.

9. The data processing system of claim 8, further comprising:
delivering means for delivering the content to the user if the content for the first location-dependent task is below the threshold.

10. The data processing system of claim 8, further comprising:
second determining means for determining if the content is time-sensitive; and
discarding means for discarding the content from the second location-dependent task storage repository when the content expires in response to a determination that the content is time-sensitive.

11. The data processing system of claim 8, wherein the receiving, determining, and rerouting steps are performed using a content service provider.

12. The data processing system of claim 8, wherein the threshold is set by the user.

13. The data processing system of claim 12, wherein the threshold is set to define a maximum number of content deliveries the user can handle for a particular task.

14. The data processing system of claim 13, wherein rerouting the content prevents the user from being interrupted with content that the user is not able to presently address.

15. A computer program product in a computer readable medium for queuing location-based task-oriented content, comprising:
first instructions for receiving content for a first location-dependent task, wherein the content is to be delivered to a particular client computing device;
second instructions for determining if the content is above a threshold associated with the first location-dependent task; and
third instructions for rerouting the content to a storage repository associated with a second location-dependent task in response to a determination that the content is above the threshold, wherein rerouting the content allows a user to address the content at a later time.

16. The computer program product of claim 15, further comprising:
fourth instructions for delivering the content to the user if the content for the first location-dependent task is below the threshold.

17. The computer program product of claim 15, further comprising:
fourth instructions for determining if the content is time-sensitive; and
fifth instructions for discarding the content from the second location-dependent task storage repository when the content expires in response to a determination that the content is time-sensitive.

18. The computer program product of claim 15, wherein the receiving, determining, and rerouting steps are performed using a content service provider.

19. The computer program product of claim 15, wherein the threshold is set by the user.

20. The computer program product of claim 19, wherein the threshold is set to define a maximum number of content deliveries the user can handle for a particular task.

21. The computer program product of claim 20, wherein rerouting the content prevents the user from being interrupted with content that the user is not able to presently address.
